(19) United States
(12) Patent Application Publication
(10) Pub. No.: US 2009/0010690 A1
(43) Pub. Date: Jan. 8, 2009

(54) CONDUCTIVE ROLLER AND IMAGE FORMING APPARATUS COMPRISING THE SAME

(75) Inventors: Hiroyuki Kanesugi, Tokyo (JP); Junji Sakata, Tokyo (JP); Shuyou Akama, Saitama (JP)

Correspondence Address: SUGHRUE MION, PLLC, 2100 PENNSYLVANIA AVENUE, N.W., SUITE 800, WASHINGTON, DC, 20037, US

(73) Assignee: BRIDGESTONE CORPORATION, CHUO-KU, TOKYO (JP)

(21) Appl. No.: 12/281,690

(22) PCT Filed: Mar. 7, 2007
(86) PCT No.: PCT/JP2007/054470

§ 371 Date: Sep. 17, 2008

(30) Foreign Application Priority Data
Mar. 7, 2006 (JP) 2006-061048
Mar. 6, 2007 (JP) 2007-056119

(51) Int. Cl. G03G 15/20

(52) U.S. Cl. 399/336

(57) ABSTRACT

This invention relates to a conductive roller having high adhesion property between an elastic layer and a coating layer, and more particularly to a conductive roller 1 comprising a shaft member 2, one or more elastic layers 3 disposed on an outside of the shaft member 2 in a radial direction and one or more coating layers 4 disposed on an outside of the elastic layer 3 in a radial direction, characterized in that at least an outermost layer of the elastic layers 3 and an innermost layer of the coating layers 4 are composed of an ultraviolet-curing type resin formed by curing an ultraviolet curable raw material mixture through ultraviolet irradiation, and (1) the raw material mixture used in the innermost layer of the coating layers 4 comprises a monomer having a heterocycle, or (2) the raw material mixture used in the innermost layer of the coating layers 4 and the raw material mixture used in the outermost layer of the elastic layers 3 comprise at least one polar group-containing monomer selected from the group consisting of a monomer having a heterocycle, a monomer having a hydroxyl group and a monomer having a carboxyl group.

### TECHNICAL FIELD

This invention relates to a conductive roller having an elastic layer and a coating layer and an image forming apparatus comprising the conductive roller, and more particularly to a conductive roller having high adhesion property between an elastic layer and a coating layer.

### BACKGROUND ART

In general, a roll-shaped conductive elastic member, i.e. a conductive roller is frequently used as a developing roller, a charging roller, a toner feed roller, a transfer roller, a paper feed roller, a cleaning roller, a pressure roller for fixing or the like in an image forming apparatus of an electro-photographic system such as a copying machine, a facsimile, a laser beam printer (LBP) or the like. The conductive roller comprises a shaft member usually journaled at both ends in a lengthwise direction thereof and at least one elastic layer disposed on an outside of the shaft member in a radial direction. Also, the conductive roller may be further provided on the surface of the elastic layer with a coating layer for the purpose of controlling the charging and adhesion property to toners, preventing the elastic layer from contaminating a photosensitive drum and so on.

As the shaft member of the conductive roller are used various resins such as engineering plastics and so on in addition to metals such as iron, stainless and so on. As the elastic layer of the conductive roller are used elastomers such as silicone rubber, acrylonitrile-butadiene rubber (NBR), ethylene-propylene-diene rubber (EPDM), epichlorohydrin rubber (ECO), polyurethane and so on, and the elastic layer is produced by poring an elastomeric raw material into a mold having a desired cavity form, heating and curing the elastomeric raw material. Furthermore, the coating layer is formed by dipping a main body of the roller comprising the shaft member and the elastic layer into a solvent-based or a water-based resin-containing coating liquid or spraying such a coating liquid onto the main roller body, and then drying and curing by heat or hot air. In this context, however, it is necessary to dry for a long time in order to form the coating layer, so that its commercial production requires a long drying line. Moreover, although the coating layer requires subtle conductivity and surface condition depending on its application, since differences of a temperature distribution, an airflow amount and the like in the drying line have a large effect on the properties of the coating layer, there is a problem in quality.

On the contrary, as a method for forming a coating layer having a stable quality without using the long drying line, there is proposed a technique which comprises applying an ultraviolet curable resin raw material on a surface of an elastic layer of a roller, and curing the resin raw material to form a coating layer composed of an ultraviolet-curing type resin on the surface of the elastic layer (see JP-A-2002-310136).

### DISCLOSURE OF THE INVENTION

Under the above situation, the inventors have found that adhesion property between an elastic layer made of an ultraviolet-curing type resin and a coating layer made of an ultraviolet-curing type resin is usually poor because the elastic layer and the coating layer are different in a curing shrinkage factor respectively and thereby a strain is caused between the elastic layer and the coating layer and there is a problem in the durability of the roller as a result of studies on the conductive roller using the ultraviolet-curing type resin in the elastic layer and the coating layer. When the roller having poor adhesion property between the elastic layer and the coating layer is used in the image forming apparatus, the coating layer is easily peeled out from the elastic layer during the use to easily cause a faulty image. Therefore, the elastic layer and the coating layer of the conductive elastic roller are also required to be sufficiently high in the adhesion property.

It is, therefore, an object of the invention to provide a conductive roller not requiring a long drying line for production, comprising a coating layer having a stable quality and further having high adhesion property between an elastic layer and a coating layer. Moreover, it is another object of the invention to provide an image forming apparatus using such a conductive roller and capable of stably forming a good image.

The inventors have made various studies in order to achieve the above objects and discovered that a conductive roller not requiring a long drying line for production, comprising a coating layer having a stable quality and further having high adhesion property between an elastic layer and a coating layer and excellent durability can be obtained by (1) forming the coating layer from an ultraviolet curable raw material composition comprising a monomer having a heterocycle, or (2) forming the coating layer and the elastic layer from an ultraviolet curable raw material composition comprising a polar group-containing monomer, and as a result the invention has been accomplished.

That is, the first conductive roller according to the invention comprises a shaft member, one or more elastic layers disposed on an outside of the shaft member in a radial direction and one or more coating layers disposed on an outside of the elastic layer in a radial direction, and is characterized in that at least an outermost layer of the elastic layers and an innermost layer of the coating layers are composed of an ultraviolet-curing type resin formed by curing an ultraviolet curable raw material mixture through ultraviolet irradiation, and the raw material mixture used in the innermost layer of the coating layers comprises a monomer having a heterocycle.

Also, the second conductive roller according to the invention comprises a shaft member, one or more elastic layers disposed on an outside of the shaft member in a radial direction and one or more coating layers disposed on an outside of the elastic layer in a radial direction, and is characterized in that at least an outermost layer of the elastic layers and an innermost layer of the coating layers are composed of an ultraviolet-curing type resin formed by curing an ultraviolet curable raw material mixture through ultraviolet irradiation, and the raw material mixture used in the innermost layer of the coating layers and the raw material mixture used in the outermost layer of the elastic layers comprise at least one polar group-containing monomer selected from the group consisting of a monomer having a heterocycle, a monomer having a hydroxyl group and a monomer having a carboxyl group. Moreover, in the second conductive roller according to the invention, it is particularly preferable that the raw material mixture used in the outermost layer of the elastic layers comprises the monomer having the carboxyl group.

Further, the image forming apparatus according to the invention is characterized by using the above-described conductive roller.

According to the invention, there can be provided the conductive roller not requiring a long drying line for production, comprising the coating layer having a stable quality and further having high adhesion property between the elastic layer and the coating layer by (1) forming the coating layer from the ultraviolet curable raw material composition comprising the monomer having the heterocycle, or (2) forming the coating layer and the elastic layer from the ultraviolet curable raw material composition comprising the polar group-containing monomer. Further, there can be provided the image forming apparatus comprising the above conductive roller and capable of stably forming a good image.

### BRIEF DESCRIPTION OF THE DRAWINGS

FIG. 1 is a sectional view of an embodiment of the conductive roller according to the invention.

FIG. 2 is a partial sectional view of an embodiment of the image forming apparatus according to the invention.

### BEST MODE FOR CARRYING OUT THE INVENTION

<Conductive Roller>

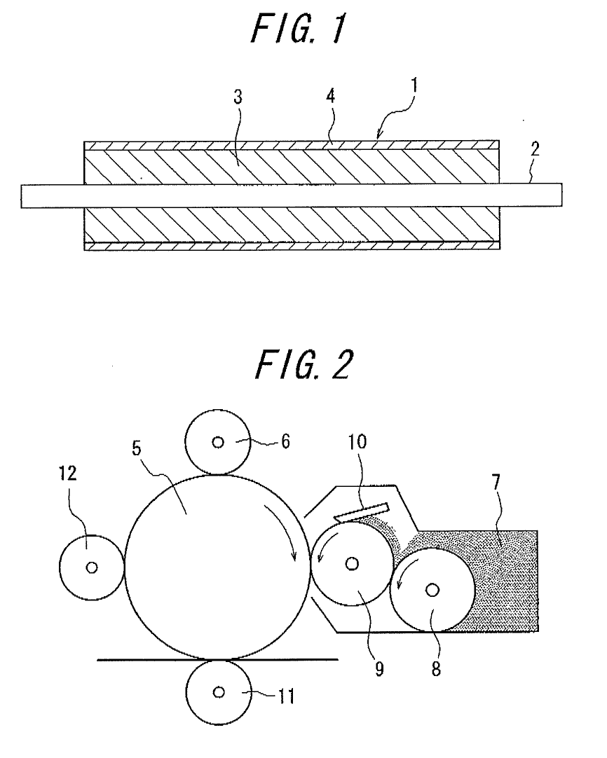

The conductive roller according to the invention will be described in detail below with reference to FIG. 1. FIG. 1 is a sectional view of an embodiment of the conductive roller according to the invention. The conductive roller 1 shown in the figure comprises a shaft member 2, an elastic layer 3 disposed on an outside of the shaft member 2 in a radial direction and a coating layer 4 disposed on an outside of the elastic layer 3 in a radial direction. Although the conductive roller 1 shown in FIG. 1 comprises only one elastic layer 3, the conductive roller according to the invention may comprise two or more elastic layers. Also, the conductive roller 1 shown in FIG. 1 comprises only one coating layer 4, but the conductive roller according to the invention may comprise two or more coating layers.

In this context, the first conductive roller according to the invention is characterized in that at least an innermost layer of the coating layers 4 is composed of an ultraviolet-curing type resin formed by curing an ultraviolet curable raw material mixture comprising a monomer having a heterocycle through ultraviolet irradiation. The monomer having the heterocycle can give tenacity and moderate elongation characteristic to the ultraviolet-curing resin. Therefore, even if the strain is caused during the curing of the coating layer, the adhesion property between the elastic layer 3 and the coating layer 4 can be sufficiently assured because the coating layer itself is tenacious and can elongate moderately.

Also, the second conductive roller according to the invention is characterized in that at least an innermost layer of the coating layers 4 and at least an outermost layer of the elastic layers 3 are composed of an ultraviolet-curing type resin formed by curing an ultraviolet curable raw material mixture comprising at least one polar group-containing monomer selected from the group consisting of a monomer having a heterocycle, a monomer having a hydroxyl group and a monomer having a carboxyl group. In the second conductive roller according to the invention, since the innermost layer of the coating layers and the outermost layer of the elastic layers have at least one polar group selected from the group consisting of a heterocycle, a hydroxyl group and a carboxyl group, the polar group in the innermost layer of the coating layers interacts with the polar group in the outermost layer of the elastic layers and thereby the adhesion property between the elastic layer 3 and the coating layer 4 can be sufficiently assured.

Moreover, when at least the innermost layer of the coating layers 4 is composed of the ultraviolet-curing type resin formed by curing the ultraviolet curable raw material mixture comprising the monomer having the heterocycle through ultraviolet irradiation and at least the outermost layer of the elastic layers 3 is composed of the ultraviolet-curing type resin formed by curing the ultraviolet curable raw material mixture comprising the monomer having the carboxyl group through ultraviolet irradiation, the adhesion property between the elastic layer 3 and the coating layer 4 is particularly good because the coating layer itself is tenacious and can elongate moderately and further the polar group in the innermost layer of the coating layers interacts with the carboxyl group in the outermost layer of the elastic layers.

The monomer having the heterocycle used in the raw material mixture for the innermost layer in the coating layers of the first and second conductive rollers according to the invention as well as the raw material mixture for the outermost layer in the elastic layers of the second conductive roller according to the invention is required to have a heterocycle in its molecule and is preferable to have a (metha)acryloyloxy group to be cured with ultraviolet rays. As the heterocycle group are mentioned morpholino group, tetrafurfuryl group, pyrrolidonyl group, caprolactonyl group and so on. As the monomer having the heterocycle are concretely mentioned acryloyl morpholine, methacryloyl morpholine, tetrahydrofurfuryl (metha)acrylate, N-vinyl pyrrolidone, N-vinyl caprolactam and so on. These monomers having the heterocycle may be used alone or in a combination of two or more.

The monomer having the hydroxyl group used in the raw material mixture for the innermost layer in the coating layers and the raw material mixture for the outermost layer in the elastic layers of the second conductive roller according to the invention is required to have a hydroxyl group in its molecule and is preferable to have a (metha)acryloyloxy group to be cured with ultraviolet rays. As the monomer having the hydroxyl group are concretely mentioned 2-hydroxyethyl acrylate, 2-hydroxypropyl acrylate, 2-hydroxybutyl acrylate, pentaerythritol triacrylate, 2-hydroxyethyl methacrylate, 2-hydroxypropyl methacrylate, 2-hydroxybutyl methacrylate, an adduct of phenyl glycidyl ether with acrylic acid, 2-hydroxy-3-phenoxypropyl acrylate and so on. These monomers having the hydroxyl group may be used alone or in a combination of two or more.

The monomer having the carboxyl group used in the raw material mixture for the innermost layer in the coating layers and the raw material mixture for the outermost layer in the elastic layers of the second conductive roller according to the invention is required to have a carboxyl group in its molecule and is preferable to have a (metha)acryloyloxy group to be cured with ultraviolet rays. As the monomer having the carboxyl group are concretely mentioned β-(metha)acryloyloxyethyl hydrogen succinate, β-(metha)acryloyloxypropyl hydrogen succinate, β-(metha)acryloyloxyethyl hydrogen phthalate, β-(metha)acryloyloxypropyl hydrogen phthalate, β-(metha)acryloyloxyethyl hydrogen tetrahydrophthalate, β-(metha)acryloyloxypropyl hydrogen tetrahydrophthalate, β-(metha)acryloyloxyethyl hydrogen hexahydrophthalate, β-(metha)acryloyloxypropyl hydrogen hexahydrophthalate, β-tris(acryloyloxymethyl)ethyl hydrogen phthalate and so on. These monomers having the carboxyl group may be used alone or in a combination of two or more.

In the first conductive roller according to the invention, the content of the monomer having the heterocycle in the raw material mixture for the innermost layer of the coating layers is preferably within a range of 20 to 70% by mass. When the content of the monomer having the heterocycle in the raw material mixture for the innermost layer of the coating layers is less than 20% by mass, it is difficult to give tenacity and moderate elongation characteristic to the innermost layer of the coating layers, while when it exceeds 70% by mass, a hardness of the coating may be increased to cause a crack of the coating during printing.

In the second conductive roller according to the invention, the content of the polar group-containing monomer in the raw material mixture for the innermost layer of the coating layers is preferably within a range of 30 to 80% by mass. When the content of the polar group-containing monomer in the raw material mixture for the innermost layer of the coating layers is less than 30% by mass, it is difficult to give the sufficient adhesion property between the innermost layer of the coating layers and the outermost layer of the elastic layers, while when it exceeds 80% by mass, an elongation of the coating may be deteriorated to cause a breakage.

In the second conductive roller according to the invention, the content of the polar group-containing monomer in the raw material mixture for the outermost layer of the elastic layers is preferably within a range of 10 to 80% by mass. When the content of the polar group-containing monomer in the raw material mixture for the outermost layer of the elastic layers is less than 10% by mass, it is difficult to give the sufficient adhesion property between the innermost layer of the coating layers and the outermost layer of the elastic layers, while when it exceeds 80% by mass, an elongation of the coating may be deteriorated to cause a breakage.

The ultraviolet curable raw material mixture used for forming the innermost layer of the coating layers is preferable to further comprise an acrylate oligomer, a reactive diluent, a photo-polymerization initiator, a microparticle, a conductive agent and so on. Also, the ultraviolet curable raw material mixture used for forming the outermost layer of the elastic layers is preferable to further comprise an acrylate oligomer, a reactive diluent, a photo-polymerization initiator, a conductive agent and so on. Moreover, the coating layer(s) except the innermost layer is not particularly limited and may be similar to or different from the innermost layer in the conductive roller according to the invention. Also, the elastic layer(s) except the outermost layer is not particularly limited and may be similar to or different from the outermost layer in the conductive roller according to the invention.

As the acrylate oligomer preferably used in the ultraviolet curable raw material mixture are mentioned urethane-based acrylate oligomer, epoxy-based acrylate oligomer, ether-based acrylate oligomer, ester-based acrylate oligomer, polycarbonate-based acrylate oligomer, fluorine-based acrylate oligomer, silicone-based acrylate oligomer and so on. The above acrylate oligomer can be synthesized by a reaction of polyethylene glycol, polyoxypropylene glycol, polytetramethylene ether glycol, bisphenol A-type epoxy resin, phenolic novolac-type epoxy resin, an adduct of polyalcohol and ε-caprolactone or the like and an acrylic acid, or an urethanation of a polyisocyanate compound and an acrylate compound having a hydroxy group.

The urethane-based acrylate oligomer can be obtained by an urethanation of a polyol, an isocyanate compound and an acrylate compound having a hydroxy group. As the epoxy-based acrylate oligomer is preferable a reaction product of a compound having a glycidyl group and an acrylic acid, and more preferable a reaction product of a compound having a cyclic structure such as a benzene ring, a naphthalene ring, a spiro ring, dicyclopentadien, tricyclodecane or the like and a glycidyl group and an acrylic acid. The ether-based acrylate oligomer, the ester-based acrylate oligomer and the polycarbonate-based acrylate oligomer can be obtained by a reaction of a polyol (polyether polyol, polyester polyol, and polycarbonate polyol) corresponding to each oligomer and an acrylic acid.

The ultraviolet curable raw material mixture may comprise an acrylate monomer as a reactive diluent. As the acrylate monomer are mentioned ethyl acrylate, isobutyl acrylate, n-butyl acrylate, isoamyl acrylate, methoxytriethyleneglycol acrylate, lauryl acrylate, isomyristyl acrylate, stearyl acrylate, myristyl acrylate, palmityl acrylate and so on. These acrylate monomers may be used alone or in a combination of two or more.

The ultraviolet curable raw material mixture preferably comprises a photo-polymerization initiator. The photo-polymerization initiator has an action of initiating polymerization of the above-mentioned monomer and acrylate oligomer through ultraviolet irradiation. As the photo-polymerization initiator are mentioned 4-dimethylaminobenzoic acid, 4-dimethylaminobenzoic ester, 2,2-dimethoxy-2-phenylacetophenone, acetophenone diethyl ketal, alkoxyacetophenone, benzyl dimethyl ketal, benzophenone, benzophenone derivatives such as 3,3-dimethyl-4-methoxy benzophenone, 4,4-dimethoxy benzophenone, 4,4-diamino benzophenone and the like, alkyl benzoylbenzoate, bis(4-dialkylaminophenyl)ketone, benzyl, benzyl derivatives such as benzyl methyl ketal and the like, benzoin, benzoin derivatives such as benzoin isobutyl ether and the like, benzoin isopropyl ether, 2-hydroxy-2-methyl propiophenone, 1-hydroxycyclohexyl phenyl ketone, xanthone, thioxanthone, thioxanthone derivatives, fluorene, 2,4,6-trimethylbenzoyldiphenylphosphine oxide, bis(2,6-dimethoxybenzoyl)-2,4,4-trimethylpentylphosphine oxide, bis(2,4,6-trimethylbenzoyl)-phenylphosphine oxide, 2-methyl-1-[4.-(methylthio)phenyl]-2-morpholinopropanone-1,2-benzyl-2-dimethylamino-1-(morpholinophenyl)-butanone-1 and the like. These photo-polymerization initiators may be used alone or in a combination of two or more. The amount of the photo-polymerization initiator compounded in the ultraviolet curable raw material mixture is preferably within a range of 0.2 to 5.0 parts by mass based on 100 parts by mass of the total amount of the monomer and the acrylate oligomer. When the amount of the photo-polymerization initiator compounded is less than 0.2 part by mass, the effect of initiating the ultraviolet curing of the raw material mixture is small, while when it exceeds 5.0 parts by mass, the effect of initiating the ultraviolet curing is saturated and the cost of the raw material mixture becomes high.

The ultraviolet curable raw material mixture for forming the coating layer may further comprises microparticles. On the surface of the conductive roller can be properly formed a micro-unevenness by compounding the microparticle into the raw material mixture for the coating layer. As the microparticle are preferable microparticles of a rubber, an urethane or a synthetic resin and inorganic microparticles such as carbon microparticles, silica-based microparticles. Particularly, microparticles of silicone rubber, silicone resin, fluorocarbon resin, urethane resin, polyolefin resin, epoxy resin, polystyrene resin, urethane acrylate, melamine resin, phenol resin, (metha)acrylic-based resin and glassy carbon, and silica microparticles are preferable. These microparticles may be used alone or in a combination of two or more. Moreover, the content of the microparticle is preferably within a range of 0.1 to 100 parts by mass based on 100 parts by mass of the total amount of the monomer and the acrylate oligomer.

To the ultraviolet curable raw material mixture may be added a conductive agent in order to give an electric conductivity to the coating layer and the elastic layer, and as the conductive agent are mentioned an ion conductive agent, an electron conductive agent and the like. As the ion conductive agent are mentioned ammonium salts such as perchlorate, chlorate, hydrochloride, bromate, iodate, hydroborofluoride, sulfate, ethylsulfate, carboxylate and sulfonate of tetraethyl ammonium, tetrabutyl ammonium, dodecyltrimethyl ammonium, hexadecyltrimethyl ammonium, benzyltrimethyl ammonium and modified-fatty acid dimethylethyl ammonium and the like; perchlorate, chlorate, hydrochloride, bromate, iodate, hydroborofluoride, sulfate, trifluoromethyl sulfate and sulfonate of an alkali metal or an alkali earth metal such as lithium, sodium, potassium, calcium, magnesium or the like. As the electron conductive agent are mentioned conductive carbons such as Ketjen black, acetylene black and the like; carbon blacks for rubber such as SAF, ISAF, HAF, FEF, GPF, SRF, FT, MT and the like; carbon black for coloring agent treated by oxidation or the like; pyrolyzed carbon black, natural graphite, artificial graphite; metal oxides such as antimony-doped tin oxide, ITO, tin oxide, titanium oxide, zinc oxide and the like; metals such as nickel, copper, silver, germanium and the like; conductive polymers such as polyaniline, polypyrrole, polyacetylene and the like; conductive whiskers such as carbon whisker, graphite whisker, titanium carbide whisker, conductive potassium titanate whisker, conductive barium titanate whisker, conductive titanium oxide whisker, conductive zinc oxide whisker and the like. The amount of the conductive agent used can be properly adjusted such that the coating layer and the elastic layer have a desired electric conductivity.

The coating layer 4 is preferable to have a thickness of 5 μm to 30 μm. When the thickness of the coating layer is less than 5 μm, the effect developed by disposing the coating layer is small, while when it exceeds 30 μm, the surface of the conductive roller becomes hard and thereby the flexibility is deteriorated.

On the other hand, the elastic layer 3 is preferable to have a thickness of 500 μm to 3 mm. When the thickness of the elastic layer is not less than 500 μm, the conductive roller has a sufficient elasticity and the damage to toners is sufficiently small, while when it is not more than 3 mm, ultraviolet rays irradiated can sufficiently reach a deep portion of the elastic layer to surely cure the raw material mixture through ultraviolet irradiation, and the amount of the expensive ultraviolet-curing resin raw material used can be decreased.

The hardness of the elastic layer is not particularly limited, but is preferably not higher than 90 degrees, more preferably 20 to 80 degrees in an Asker C hardness. When the Asker C hardness of the elastic layer exceeds 90 degrees, the contact area between the conductive roller and the photosensitive drum or the like becomes small and hence the development may not be well conducted, and toners may be damaged and attached to the photosensitive drum or a layer forming blade and hence a faulty image is easily caused. On the other hand, if the hardness of the elastic layer is excessively low, a friction force between the roller and the photosensitive drum or the layer forming blade becomes large and thereby a faulty image such as jitter or the like may be caused.

The shaft member of the conductive roller according to the invention is not particularly limited as far as it has a good electrical conductivity, and as the shaft member are mentioned a metal shaft made of a metallic solid body, a hollow cylindrical body made of the metal or high-stiffness resin, a composite formed by disposing a high-stiffness resin on the outer periphery of the metal shaft and the like. When the high-stiffness resin is used in the shaft member, it is preferable that a conductive agent is added and dispersed into the high-stiffness resin to sufficiently ensure an electrical conductivity. As the conductive agent to be dispersed into the high-stiffness resin are preferable carbon black powder, graphite powder, carbon fiber, metal powder of aluminum, copper, nickel or the like, powder of a metal oxide such as tin oxide, titanium oxide, zinc oxide or the like, and a powdery conductive agent such as conductive glass powder or the like. These conductive agents may be used alone or in a combination of two or more. The amount of the conductive agent compounded is not particularly limited, but is preferably within a range of 5 to 40% by mass, more preferably within a range of 5 to 20% by mass per the whole of the high-stiffness resin.

As the material of the metal shaft and the metal cylindrical body are mentioned iron, stainless steel, aluminum and so on. Also, as the material of the high-stiffness resin base material are mentioned polyacetal, polyamide 6, polyamide 6.6, polyamide 12, polyamide 4.6, polyamide 6.10, polyamide 6.12, polyamide 11, polyamide MXD6, polybutylene terephthalate, polyphenylene oxide, polyphenylene sulfide, polyether sulfone, polycarbonate, polyimide, polyamide imide, polyether imide, polysulfone, polyether ether ketone, polyethylene terephthalate, polyarylate, liquid crystal polymer, polytetrafluoroethylene, polypropylene, ABS resin, polystyrene, polyethylene, melamine resin, phenol resin, silicone resin and so on. Among them, polyacetal, polyamide 6.6, polyamide MXD6, polyamide 6.12, polybutylene terephthalate, polyphenylene ether, polyphenylene sulfide and polycarbonate are preferable. These high-stiffness resins may be used alone or in a combination of two or more.

The conductive roller 1 according to the invention can be prepared, for example, by applying the raw material mixture for the elastic layer onto the outer surface of the shaft member 2, irradiating ultraviolet rays to form the elastic layer 3, and then applying the raw material mixture for the coating layer on the outer surface of the resulting elastic layer 3 and irradiating ultraviolet rays to form the coating layer 4. Therefore, the conductive roller according to the invention does not require a long drying line for production and comprises the coating layer having a stable quality. As the method for applying the raw material mixture for the elastic layer onto the outer surface of the shaft member and the method for applying the raw material mixture for the coating layer onto the outer surface of the elastic layer are mentioned a spraying method, a roll-coating method, a dipping method, a die coating method and the like. As a light source used for the ultraviolet irradiation are mentioned a mercury vapor lamp, a high pressure mercury vapor lamp, a super high pressure mercury vapor lamp, a metal halide lamp, a xenon lamp and the like. The conditions for the ultraviolet irradiation are properly selected depending on the components included in the raw material mixtures for the elastic layer and the coating layer, the composition, the amount applied and the like, i.e. the irradiation intensity, integral light quantity and so on may be adjusted properly.

The above-mentioned conductive roller according to the invention can be used as a developing roller, a charging roller, a toner feed roller, a transfer roller, a paper feed roller, a cleaning roller, a pressure roller for fixing or the like in an image forming apparatus.

<Image Forming Apparatus>

The image forming apparatus according to the invention is characterized by comprising the above-mentioned conductive roller. The image forming apparatus according to the invention is not particularly limited as far as it comprises the above-described conductive roller, and can be manufactured according to the known method.

The image forming apparatus according to the invention will be described in detail below with reference to FIG. 2. FIG. 2 is a partial sectional view of an embodiment of the image forming apparatus according to the invention. The illustrated image forming apparatus comprises a photosensitive drum 5 carrying an electrostatic latent image, a charging roller 6 positioned near to the photosensitive drum 5 (upside in the figure) for charging the photosensitive drum 5, a toner feed roller 8 for supplying toners 7, a developing roller 9 disposed between the toner feed roller 8 and the photosensitive drum 5, a developing blade 10 disposed near to the developing roller 9 (upside in the figure), a transfer roller 11 positioned near to the photosensitive drum 5 (downside in the figure), and a cleaning roller 12 disposed adjacent to the photosensitive drum 5. Moreover, the image forming apparatus according to the invention may further comprise known members (not shown) usually used for the image forming apparatus.

In the illustrated image forming apparatus, the charging roller 6 is contacted with the photosensitive drum 5, and a voltage is applied between the photosensitive drum 5 and the charging roller 6 to charge the photosensitive drum 5 at a constant electric potential, and then an electrostatic latent image is formed on the photosensitive drum 5 by an exposure machine (not shown). Then, the toners 7 are supplied from the toner feed roller 8 to the photosensitive drum 5 through the developing roller 9 by rotating the photosensitive drum 5, the toner feed roller 8 and the developing roller 9 in the direction shown by arrows in the figure. The toners 7 on the developing roller 9 are made to be a uniform thin layer by the developing blade 10, while since the developing roller 9 and the photosensitive drum 5 are rotated in contact with each other, the toners 7 are attached from the developing roller 9 to the electrostatic latent image on the photosensitive drum 5 to visualize the latent image. The toners 7 attached to the latent image are transferred to a recording medium such as a paper or the like by the transfer roller 11, while the remaining toners 7 on the photosensitive drum 5 after the transferring are removed by the cleaning roller 12. In the image forming apparatus according to the invention, it is possible to stably form an excellent image by using the above-mentioned conductive roller 1 having high adhesion property between the elastic layer 3 and the coating layer 4 and excellent durability, for example, as at least one of the charging roller 6, the toner feed roller 8, the developing roller 9, the transfer roller 11 and the cleaning roller 12.

### EXAMPLES

The following examples are given in illustration of the invention and are not intended as limitations thereof.

<Preparation 1 of the Main Roller Body Comprising the Elastic Layer of the UV Resin (the Case where the Raw Material Mixture for the Elastic Layer Comprises the Polar Group-Containing Monomer)>

A raw material for an elastic layer comprising 70 parts by mass of UA-334PZ [an urethane acrylate oligomer, manufactured by Shin-Nakamura Chemical Co., Ltd.], 20 parts by mass of LIGHT-ACRYLATE IM-A [isomyristyl acrylate, manufactured by Kyoei-Sha Chemical Co., Ltd.], 10 parts by mass of NK ESTER A-SA [β-acryloyloxyethyl hydrogen succinate, CH₂═CHCOOCH₂CH₂OCOCH₂CH₂COOH, manufactured by Shin-Nakamura Chemical Co., Ltd.], 1 part by mass of IRGACURE 651 [2,2-dimethoxy-1,2-diphenylethane-1-one, manufactured by Ciba Specialty Chemicals Co., Ltd.] as a photoinitiator, and 2 parts by mass of MP 100 [a complex salt of sodium perchlorate with a polyol, manufactured by Akishima Chemical Industry Co., Ltd.] as an ion conductive agent is applied onto a roller base material (shaft member) made of polybutylene terephthalate (PBT) resin having an outer diameter of 17.0 mm and inserted with a metal shaft having an outer diameter of 6.0 mm at a thickness of 1500 μm through a die coater, and then irradiated with UV at an irradiation intensity of 700 mW/cm² for 5 seconds while rotating under nitrogen atmosphere to obtain a main roller body comprising the elastic layer of the UV resin.

<Preparation 2 of the Main Roller Body Comprising the Elastic Layer of the UV Resin (the Case where the Raw Material Mixture for the Elastic Layer Dose Not Comprise the Polar Group-Containing Monomer)>

A raw material for an elastic layer comprising 70 parts by mass of UA-334PZ [an urethane acrylate oligomer, manufactured by Shin-Nakamura Chemical Co., Ltd.], 30 parts by mass of LIGHT-ACRYLATE IM-A [isomyristyl acrylate, manufactured by Kyoei-Sha Chemical Co., Ltd.], 1 part by mass of IRGACURE 651 [2,2-dimethoxy-1,2-diphenylethane-1-one, manufactured by Ciba Specialty Chemicals Co., Ltd.] as a photoinitiator, and 2 parts by mass of MP 100 [a complex salt of sodium perchlorate with a polyol, manufactured by Akishima Chemical Industry Co., Ltd.] as an ion conductive agent is applied onto a roller base material (shaft member) made of polybutylene terephthalate (PBT) resin having an outer diameter of 17.0 mm and inserted with a metal shaft having an outer diameter of 6.0 mm at a thickness of 1500 μm through a die coater, and then irradiated with UV at an irradiation intensity of 700 mW/cm² for 5 seconds while rotating under nitrogen atmosphere to obtain a main roller body comprising the elastic layer of the UV resin.

### Examples 1-5 and Comparative Examples 1-4

Then, a raw material for a coating layer having a formulation as shown in Tables 1 and 2 is applied onto the surface of the above main roller body through a roll coater and irradiated with UV at an irradiation intensity of 700 mW/cm² for 5 seconds to obtain a conductive roller having a UV coating [thickness: 10 μm] on its surface. The adhesion property between the elastic layer and the coating layer of the resulting conductive roller is tested according to a cross cut test of JIS method (JIS K 5600-5-6:1999). Concretely, 5 pieces of grids are respectively cut lengthwise and breadthwise, i.e., 25 pieces of grids are cut by a razor [manufactured by Gillette] and attached with Sellotape (registered trademark), thereafter Sellotape is peeled at once, and whether or not the grid is peeled by Sellotape is determined. In this context, the case where no grid is peeled is evaluated as a good case, while the case where one or more grids are peeled is evaluated as a bad case. The results are shown in Tables 1 and 2.

TABLE 1

| | | | | Example 1 | Example 2 | Example 3 | Example 4 | Example 5 |
|---|---|---|---|---|---|---|---|---|
| Raw | Oligomer | UF8001 *1 | parts by | 60 | 60 | 60 | 60 | 60 |
| material | Monomer | A-MO *2 | mass | 40 | 40 | — | — | — |
| for the | | N-vinyl pyrrolidone | | — | — | 40 | — | — |
| coating | | HO-A *3 | | — | — | — | 40 | — |
| layer | | A-SA *4 | | — | — | — | — | 40 |
| | | MTG-A *5 | | — | — | — | — | — |
| | | 3EG-A *6 | | — | — | — | — | — |
| | | TMP-3EO-A *7 | | — | — | — | — | — |
| | Conductive | Ketjen black *8 | | 1 | 1 | 1 | 1 | 1 |
| | agent | | | | | | | |
| | Initiator | DETX-S *9 | | 2.25 | 2.25 | 2.25 | 2.25 | 2.25 |
| | Sensitizer | DMBI *10 | | 0.75 | 0.75 | 0.75 | 0.75 | 0.75 |
| | Microparticle | CFB-101-40 *11 | | 10 | 10 | 10 | 10 | 10 |

| | | | | | |
|---|---|---|---|---|---|
| Presence or absence of the polar group-containing monomer | Absence | Presence | Absence | Presence | Presence |
| (A-SA) in the elastic layer | | | | | |
| Result of the cross cut peeling test | Good | Good | Good | Good | Good |

TABLE 2

| | | | | Comparative | Comparative | Comparative | Comparative |
|---|---|---|---|---|---|---|---|
| | | | | Example 1 | Example 2 | Example 3 | Example 4 |
| Raw | Oligomer | UF8001 *1 | parts by | 60 | 60 | 50 | 50 |
| material | Monomer | A-MO *2 | mass | — | — | — | — |
| for the | | N-vinyl pyrrolidone | | — | — | — | — |
| coating | | HO-A *3 | | 40 | — | — | — |
| layer | | A-SA *4 | | — | — | — | — |
| | | MTG-A *5 | | — | 40 | 30 | 30 |
| | | 3EG-A *6 | | — | — | 20 | — |
| | | TMP-3EO-A *7 | | — | — | — | 20 |
| | Conductive | Ketjen black *8 | | 1 | 1 | 1 | 1 |
| | agent | | | | | | |
| | Initiator | DETX-S *9 | | 2.25 | 2.25 | 2.25 | 2.25 |
| | Sensitizer | DMBI *10 | | 0.75 | 0.75 | 0.75 | 0.75 |
| | Microparticle | CFB-101-40 *11 | | 10 | 10 | 10 | 10 |

| | | | | |
|---|---|---|---|---|
| Presence or absence of the polar group-containing monomer | Absence | Presence | Presence | Presence |
| (A-SA) in the elastic layer | | | | |
| Result of the cross cut peeling test | Bad | Bad | Bad | Bad |

*1 Urethane acrylate oligomer, manufactured by Kyoei-Sha Chemical Co., Ltd.
*2 Morpholino group-containing monomer, manufactured by Shin-Nakamura Chemical Co., Ltd., morpholine acrylate
*3 Hydroxyl group-containing monomer, manufactured by Kyoei-Sha Chemical Co., Ltd., 2-hydroxyethyl acrylate
*4 Carboxyl group-containing monomer, manufactured by Shin-Nakamura Chemical Co., Ltd., β-acryloyloxyethyl hydrogen succinate, CH₂═CHCOOCH₂CH₂OCOCH₂CH₂COOH
*5 Ethylene oxide group-containing monomer, manufactured by Kyoei-Sha Chemical Co., Ltd., methoxytriethyleneglycol acrylate
*6 Ethylene oxide group-containing bifunctional monomer, manufactured by Kyoei-Sha Chemical Co., Ltd., triethyleneglycol diacrylate
*7 Ethylene oxide group-containing trifunctional monomer, manufactured by Kyoei-Sha Chemical Co., Ltd., EO-modified trimethylolpropane triacrylate
*8 Ketjen Black ECP600JD, manufactured by Lion Corporation
*9 2,4-diethyl thioxanthone, manufactured by Nippon Kayaku Co., Ltd.
*10 p-dimethylaminobenzoic acid isoamyl ester, manufactured by Nippon Kayaku Co., Ltd.
*11 BURNOCK CFB-101-40, manufactured by Dainippon Ink and Chemicals, Inc., cross-linked urethane

As seen from Examples 1 and 3, the conductive roller provided with the coating layer composed of an ultraviolet-curing type resin formed by curing a raw material mixture comprising a monomer having a heterocycle through ultraviolet irradiation is high in the adhesion property between the elastic layer and the coating layer.

Further, as seen from Examples 2, 4 and 5, the conductive roller provided with the elastic layer composed of an ultraviolet-curing type resin formed by curing a raw material mixture comprising a monomer having a carboxyl group through ultraviolet irradiation and the coating layer composed of an ultraviolet-curing type resin formed by curing a raw material mixture comprising a monomer having a heterocycle, a monomer having a hydroxyl group or a monomer having a carboxyl group through ultraviolet irradiation is high in the adhesion property between the elastic layer and the coating layer.

On the other hand, as seen from Comparative example 1, the adhesion property between the elastic layer and the coating layer is low, when the elastic layer is composed of an ultraviolet-curing type resin formed by curing a raw material mixture not comprising a polar group-containing monomer through ultraviolet irradiation, even if the coating layer is composed of an ultraviolet-curing type resin formed by curing a raw material mixture comprising a polar group-containing monomer through ultraviolet irradiation.

Further, as seen from Comparative examples 2-4, the adhesion property between the elastic layer and the coating layer is low, when the coating layer is composed of an ultraviolet-curing type resin formed by curing a raw material mixture not comprising a polar group-containing monomer through ultraviolet irradiation, even if the elastic layer is composed of an ultraviolet-curing type resin formed by curing a raw material mixture comprising a polar group-containing monomer through ultraviolet irradiation.

1. A conductive roller comprising a shaft member, one or more elastic layers disposed on an outside of the shaft member in a radial direction and one or more coating layers disposed on an outside of the elastic layer in a radial direction, characterized in that at least an outermost layer of the elastic layers and an innermost layer of the coating layers are composed of an ultraviolet-curing type resin formed by curing an ultraviolet curable raw material mixture through ultraviolet irradiation, and the raw material mixture used in the innermost layer of the coating layers comprises a monomer having a heterocycle.

2. A conductive roller comprising a shaft member, one or more elastic layers disposed on an outside of the shaft member in a radial direction and one or more coating layers disposed on an outside of the elastic layer in a radial direction, characterized in that at least an outermost layer of the elastic layers and an innermost layer of the coating layers are composed of an ultraviolet-curing type resin formed by curing an ultraviolet curable raw material mixture through ultraviolet irradiation, and the raw material mixture used in the innermost layer of the coating layers and the raw material mixture used in the outermost layer of the elastic layers comprise at least one polar group-containing monomer selected from the group consisting of a monomer having a heterocycle, a monomer having a hydroxyl group and a monomer having a carboxyl group.

3. A conductive roller according to claim 2, wherein the raw material mixture used in the outermost layer of the elastic layers comprises the monomer having the carboxyl group.

4. An image forming apparatus comprising a conductive roller as claimed in any one of claims 1-3.
